(19) United States
(12) Patent Application Publication
(10) Pub. No.: US 2002/0034033 A1
(43) Pub. Date: Mar. 21, 2002

(54) Active actuator for shock wave control in a data storage device

(76) Inventors: Seong-Woo Kang, Santa Clara, CA (US); Dong-Ho Oh, Santa Clara, CA (US); Tae-Yeon Hwang, Cupertino, CA (US); Yun-Sik Han, Santa Clara, CA (US); Young Son, San Jose, CA (US)

Correspondence Address: Ben J. Yorks, IRELL & MANELLA, LLP, Ste 400, 840 Newport Center Drive, Newport Beach, CA, 92660, US

(21) Appl. No.: 09/847,735

(22) Filed: May 1, 2001

Related U.S. Application Data
(60) Provisional application No. 60/233,600, filed on Sep. 18, 2000.

(51) Int. Cl. G11B 21/02; G11B 5/48

(52) U.S. Cl. 360/75; 360/244

(57) ABSTRACT

An actuator that can vary the gram load of a suspension arm of a hard disk drive. The actuator may be a shape memory alloy, piezoelectric transducer, or other means for deflecting and changing the gram load of a suspension arm of an actuator arm assembly. When the disk drive is not operating the gram load may be set to a high value that will prevent head slapping. The gram load of the suspension arm may be varied by the actuator to reduce the gram load when the disk drive is operating.

### REFERENCE TO CROSS-RELATED APPLICATIONS

This application claims priority to provisional application Ser. No. 60/233,600 filed on Sep. 18, 2000.

### BACKGROUND OF THE INVENTION

1. Field of the Invention

The present invention relates to an actuator arm assembly of a hard disk drive that has an actuator to vary a gram load of a suspension arm of the assembly.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a suspension arm to create an subassembly commonly referred to as a head gimbal assembly (“HGA”). The HGA's are attached to an actuator arm which has a voice coil motor that can move the heads across the surfaces of the disks.

Each head has an air bearing surface that cooperates with an air flow generated by the rotating disk to create an air bearing. The air bearing prevents mechanical wear between the head and the disk.

The disk drive may be subjected to external shock loads that cause heads to slap the disk. For example, the disk drive may be assembled into a portable computer that is dropped by an end user. The shock associated with dropping the computer may cause the heads to initially deflect away from the disks and then rebound in the opposite direction to strike the disk surfaces. Such a phenomenon is commonly referred to as head slapping. Head slapping may cause damage to the heads and/or disks.

There have been developed a number of different schemes to compensate for head slapping including mechanical stops that limit the movement of the heads away from the disks. These prior art schemes are not always effective in eliminating head slapping. It would be desirable to provide a hard disk drive that would reduce the occurrences of head slapping.

### BRIEF SUMMARY OF THE INVENTION

One embodiment of the present invention is an actuator arm assembly of a hard disk drive which has an actuator that can vary a gram load of a suspension arm of the assembly.

### BRIEF DESCRIPTION OF THE DRAWINGS

FIG. 1 is a top view of an embodiment of a hard disk drive of the present invention;

FIGS. 2a-b are side views of an actuator arm assembly with a shape memory alloy actuator that can vary a gram load of a suspension arm;

FIG. 3 is a table showing a correlation between head slapping and gram load of a suspension arm;

FIGS. 4a-b are side views of an alternate embodiment of an actuator arm assembly;

FIGS. 5a-b are side views of an alternate embodiment of an actuator arm assembly;

FIG. 6 is a schematic of an electrical system of the hard disk drive.

### DETAILED DESCRIPTION OF THE PREFERRED EMBODIMENT

In general one embodiment of the present invention includes an actuator that can vary the gram load of a suspension arm of a hard disk drive. The actuator may be a shape memory alloy, piezoelectric transducer, or other means for deflecting and changing the gram load of a suspension arm of an actuator arm assembly. When the disk drive is not operating the gram load may be set to a high value that will prevent head slapping. The gram load of the suspension arm may be varied by the actuator to reduce the gram load when the disk drive is operating.

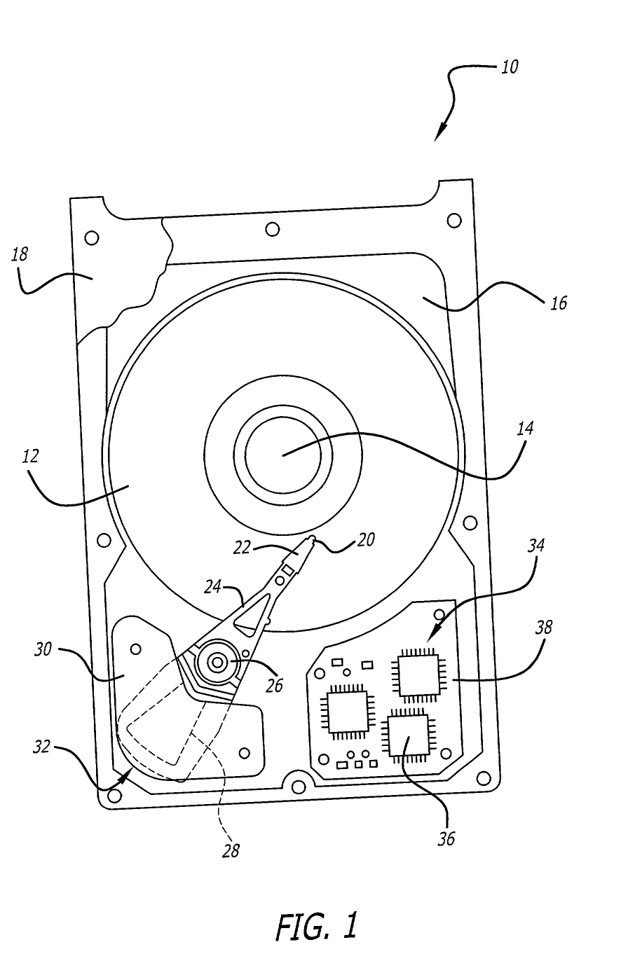

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a suspension arm 22 as part of a head gimbal assembly (HGA). The suspension arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The formation of the air bearing and the general operation of the head 20 is a function of a force exerted by the suspension arm 22. The force is commonly referred to as the gram load of the arm 22. A higher gram load corresponds to a stiffer suspension arm 22.

The hard disk drive 10 may include a printed circuit board assembly 36 that includes a plurality of integrated circuits 38 coupled to a printed circuit board 40. The printed circuit board 38 is coupled to the voice coil 28, heads 20 and spindle motor 14 by wires (not shown).

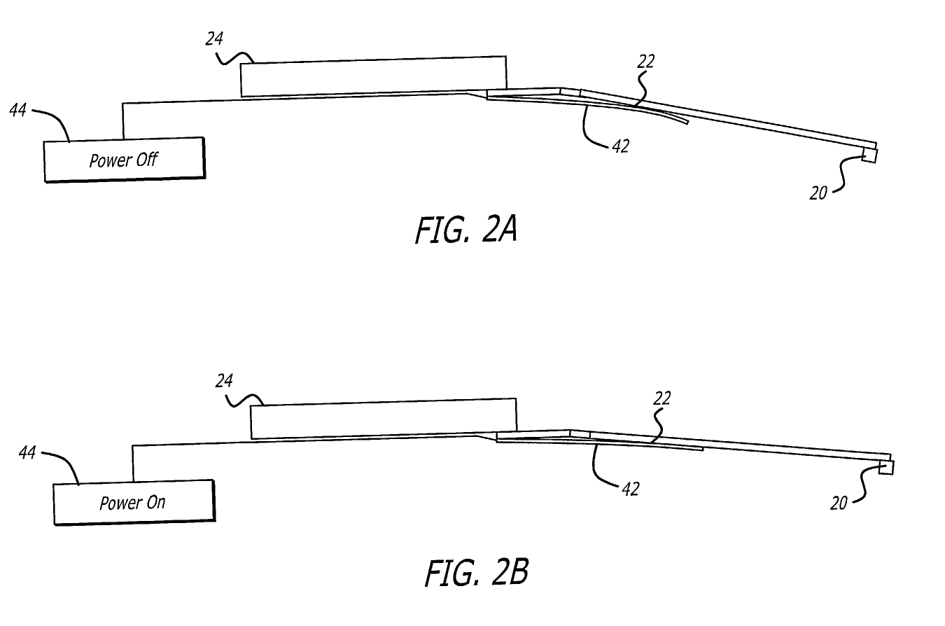

FIGS. 2a and 2b show an embodiment of the present invention which includes an actuator 42 that can vary a gram load of the suspension arm 22. The actuator 42 may be a shape memory alloy (“SMA”) that will change shape in response to a change in temperature. For example, the SMA actuator 42 may be constructed from a material that changes from a Martensite phase to an Austenite phase when the temperature of the SMA material exceeds a critical temperature. The change in the metallurgical phase causes the actuator 42 to move between a first deformed state shown in FIG. 2a to an initial memorized shape shown in FIG. 2b.

The temperature of the SMA actuator 42 can be controlled by a power source 44. The actuator 42 may be configured as an electrical element that receives current from the power source 44. Current flow through the actuator 42 will generate heat that increases the temperature of the SMA material. Alternatively, the actuator 42 may include a separate resistive element (not shown) that is attached to SMA material and coupled to the power supply 44.

When the disk drive is not in operation, the power supply 44 does not provide current so that the actuator 42 is in the initial deformed state shown in FIG. 2a. In the initial deformed state the suspension arm 22 provides a relatively high gram load. When the drive become operational, the power supply 44 activates the actuator 42 to the initial memorized shape. In the memorized shape, the actuator 42 deflects the suspension arm 22 as indicated by the arrow in FIG. 2b. Deflecting the suspension arm 22 reduces the gram load of the head 20.

The increase in gram load in the non-operational state shown in FIG. 2b, reduces the probability of the head slapping in response to a shock load. In one embodiment, the gram load is varied from 2-3 grams when the SMA actuator 42 is in the initial memorized shape to 7-8 grams when the actuator 42 is in the deformed state shown in FIG. 2b.

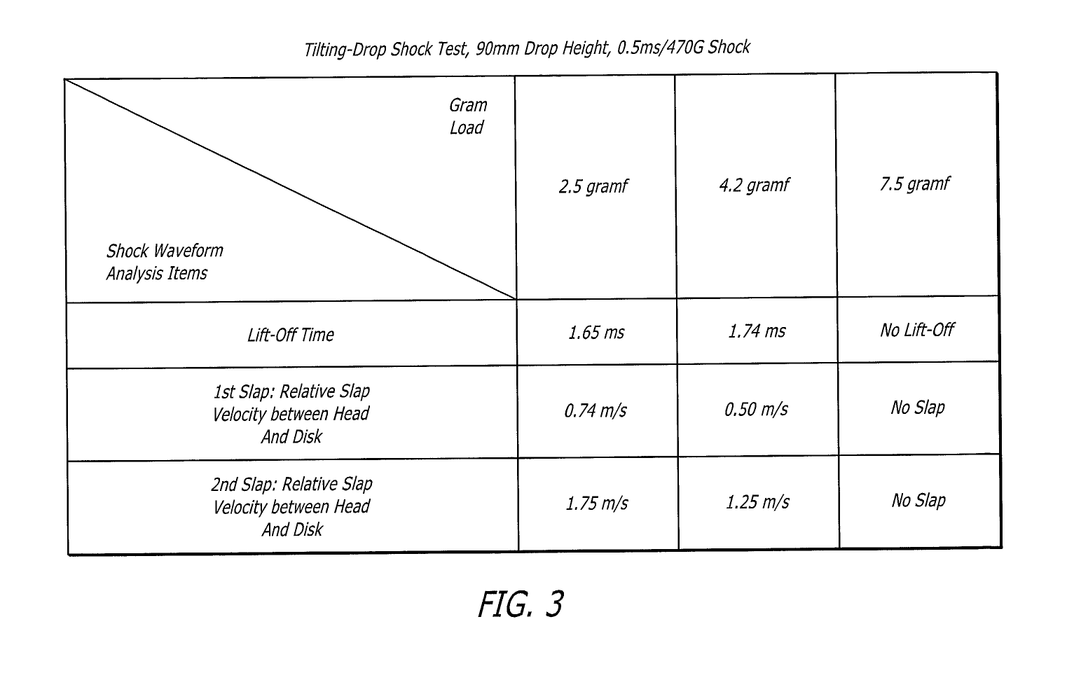

FIG. 3 is a table showing a correlation between gram load and head slap velocity in response to a shock load. As shown in FIG. 3 a higher gram load will reduce or eliminate head slapping. The gram load must be reduced during operation to allow the head to “fly” above the disk to read and write information. The actuator 42 thus provides a means to vary the gram load and minimize the likelihood of a head slapping event when the disk drive is not operating.

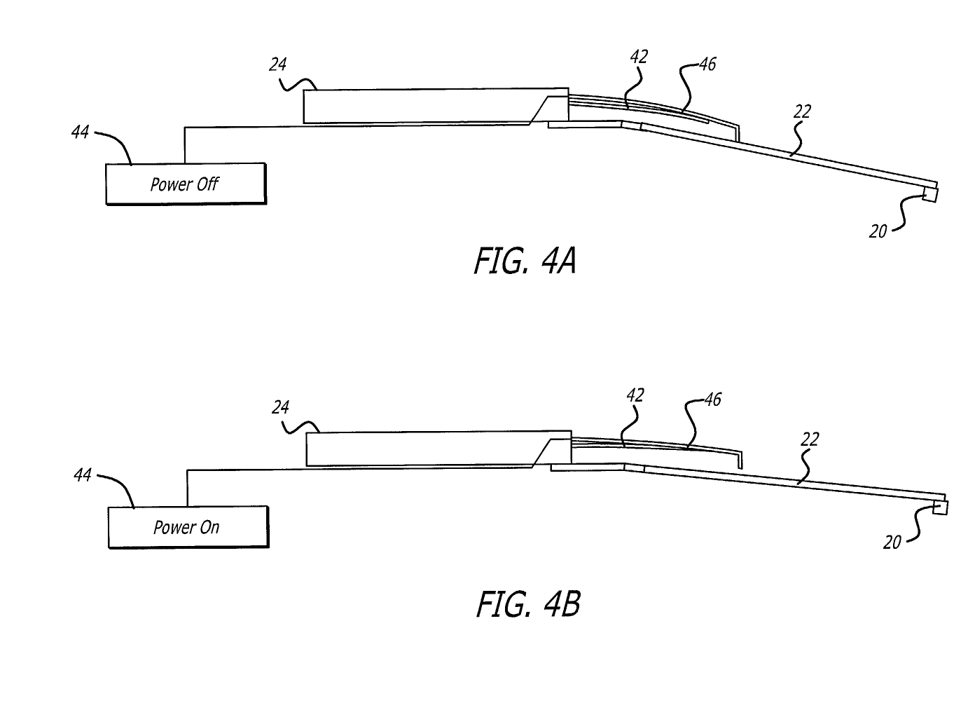

FIGS. 4a and 4b show an alternate embodiment that includes a stop arm 46 which controls the deflection of the suspension arm 22. The actuator 42 may be constructed from a SMA material. In this embodiment, the actuator 42 allows the stop arm 46 to deflect the suspension arm 22 and increase the gram load when the actuator 42 is in the initial deformation shape shown in FIG. 4a. The higher gram load will reduce head slapping. Activating the actuator 42, will deflect the stop arm 46 and allow the suspension arm 22 to spring back to a low gram load state as indicated by the arrow shown in FIG. 4b.

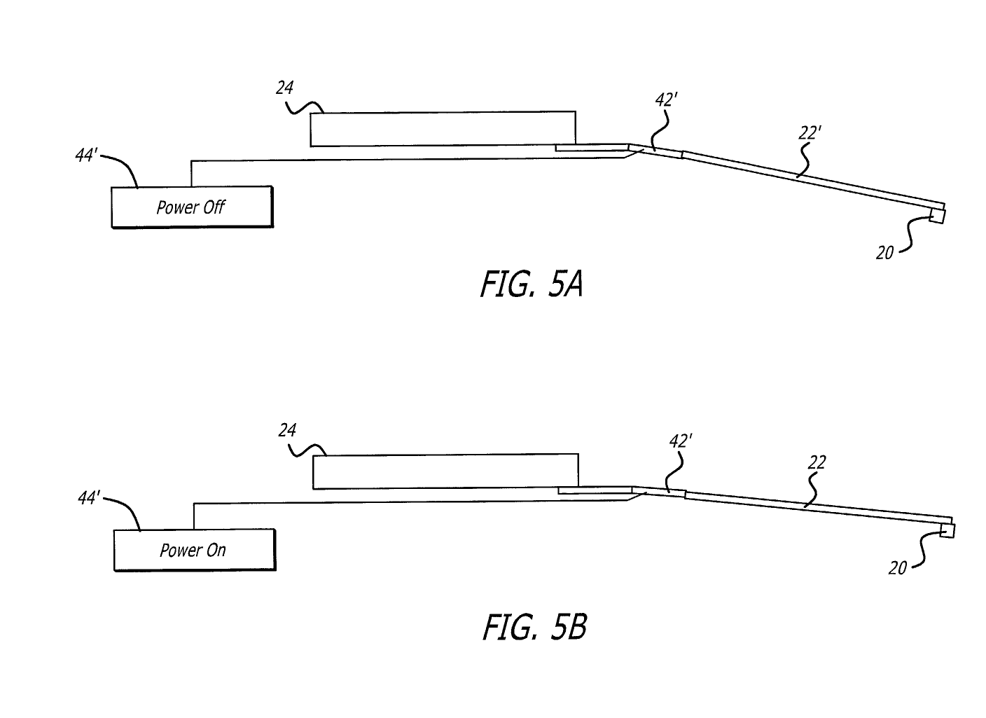

FIGS. 5a and 5b show an alternate embodiment wherein the actuator 42′ include a piezoelectric (“PZT”) material. The actuator 42′ may be constructed as a joint of the suspension arm 22′. The actuator 42′ may be coupled to a power supply 44′ that provides a voltage to the PZT material.

When the disk drive is not operating, the power supply 44′ does not provide a voltage to the PZT material and the suspension arm 22′ has a high gram load as shown in FIG. 5a. When the disk drive is operational, the power supply 44′ provides a voltage to the PZT material. The voltage causes the suspension arm 22 to bend to the low gram load state shown in FIG. 5b.

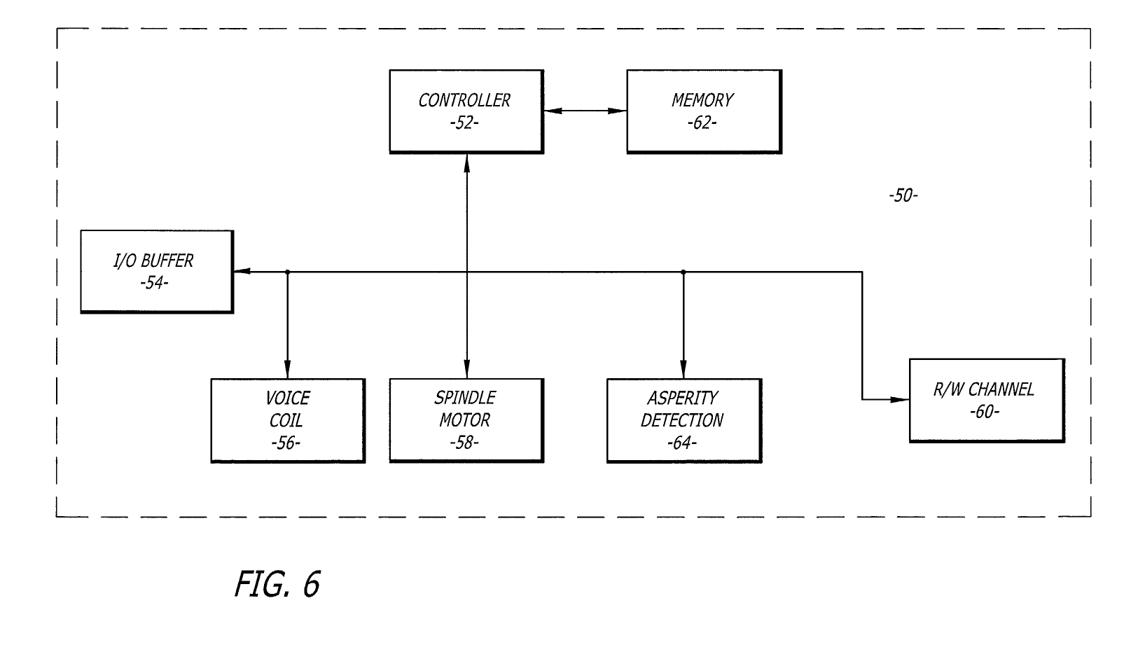

FIG. 6 shows a schematic of an electrical system 50 that can control the disk drive 10. The system 50 includes a controller 52 that is connected to an input/output (I/O) buffer 54, voice coil motor control circuit 56, spindle motor control circuit 58, read/write channel circuit 60, memory 62. The I/O buffer 54 provides an interface with an external source such as a personal computer. The voice coil control circuit 56 and spindle motor control circuit 58 contain drivers, etc. to control the voice coil motor and spindle motor, respectively.

The voice coil motor circuit 56 and spindle motor control circuit 58 operate in accordance with signals, commands, etc. from the controller 52. The controller 52 may be a processor that can perform software routines in accordance with instructions and data to operate the storage and retrieval of information from the disks 12. The controller 52 may provide commands/signals to control the on/off state of the power supply 44 or 44′ and vary the gram load on the heads 20.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An actuator arm assembly for a hard disk drive, comprising:
an actuator arm;
a suspension arm coupled to said actuator arm, said suspension arm having a gram load;
a head coupled to said suspension arm; and, an actuator that varies the gram load of said suspension arm.

2. The assembly of claim 1, wherein said actuator deflects said suspension arm.

3. The assembly of claim 1, further comprising a stop arm that can engage said suspension arm, wherein said stop arm is deflected by said actuator.

4. The assembly of claim 1, wherein said actuator includes a shape memory allow material.

5. The assembly of claim 1, wherein said actuator includes a piezoelectric material.

6. The assembly of claim 1, further comprising a power supply to actuate said actuator.

7. The assembly of claim 1, wherein the gram force varies from a range of approximately 2-3 grams to a range of approximately 7-8 grams.

8. A hard disk drive, comprising:
a base plate;
a spindle motor coupled to said base plate;
a disk coupled to said spindle motor;
an actuator arm mounted to said base plate;
a voice coil motor coupled to said actuator arm;
a suspension arm coupled to said actuator arm, said suspension arm having a gram load;
a head coupled to said suspension arm and said disk; and,
an actuator that varies the gram load of said suspension arm.

9. The hard disk drive of claim 8, wherein said actuator deflects said suspension arm.

10. The hard disk drive of claim 8, further comprising a stop arm that can engage said suspension arm, wherein said stop arm is deflected by said actuator.

11. The hard disk drive of claim 8, wherein said actuator includes a shape memory allow material.

12. The hard disk drive of claim 8, wherein said actuator includes a piezoelectric material.

13. The hard disk drive of claim 8, further comprising a power supply to actuate said actuator.

14. The hard disk drive of claim 1, wherein the gram force varies from a range of approximately 2-3 grams to a range of approximately 7-8 grams.

15. A method for varying a gram load of a suspension arm of a hard disk drive, comprising:
actuating an actuator to vary the gram load of a suspension arm that is coupled to a head and an actuator arm.

16. The method of claim 15, wherein the suspension arm is deflected by the actuator.

17. The method of claim 16, wherein the actuation of the actuator lowers the gram load of the suspension arm.

18. The method of claim 17, wherein the gram load is lowered from a range of approximately 7-8 grams to a gram load of approximately 2-3 grams.
